(19) United States
(12) Patent Application Publication
(10) Pub. No.: US 2021/0133673 A1
(43) Pub. Date: May 6, 2021

(54) SERVER APPARATUS, MEDIUM, AND OPERATION METHOD FOR INFORMATION PROCESSING SYSTEM

(71) Applicant: TOYOTA JIDOSHA KABUSHIKI KAISHA, Toyota-shi (JP)

(72) Inventors: Ryosuke KOBAYASHI, Nagakute-shi (JP); Ayana TAKESHITA, Kasugai-shi (JP); Naoki YAMAMURO, Nagoya-shi (JP); Takuya MAEKAWA, Nagoya-shi (JP); Yugo SAKURAI, Setagaya-ku (JP)

(73) Assignee: TOYOTA JIDOSHA KABUSHIKI KAISHA, Toyota-shi (JP)

(21) Appl. No.: 17/074,778

(22) Filed: Oct. 20, 2020

(30) Foreign Application Priority Data
Nov. 1, 2019 (JP) 2019-200200

(51) Int. Cl. G06Q 10/08; G06Q 30/06; G06Q 10/06; G06Q 20/08; G06Q 30/02; G05D 1/02

(52) U.S. Cl. CPC G06Q 10/0837; G06Q 30/0645; G06Q 10/06315; G05D 1/0282; G06Q 30/0284; G06Q 30/0208; G06Q 20/085

(57) ABSTRACT

A server apparatus includes a communication interface and a controller configured to transmit and receive information to and from another apparatus via the communication interface. The controller receives, from a first terminal apparatus, a collection request involving collection of a purchased or rented article to be returned at a collection point, receives, from a second terminal apparatus, a delivery request for the article involving delivery to a delivery destination, and transmits, to a mobile object, an instruction to collect the article at the collection point and deliver the article to the delivery destination without going through a base for storing the collected article.

### CROSS-REFERENCE TO RELATED APPLICATIONS

The present application claims priority from Japanese Patent Application No. 2019-200200, filed on Nov. 1, 2019, the entire disclosure of which is incorporated herein by reference.

### TECHNICAL FIELD

The present disclosure relates to a server apparatus, a medium, and an operation method for an information processing system.

### BACKGROUND

Mail-order sale of various items by means of electronic commerce is known. For example, a purchasing customer purchases an item from an electronic commerce (EC) website of a sales business operator over the Internet, and receives delivery of the item at a desired point. In such a mail-order system, the sales business operator is generally required to accept exchange or return of the item purchased by the purchasing customer. JP2006236018A (PTL 1) discloses a system supporting resale of a returned item.

### CITATION LIST

### Patent Literature

PTL 1: JP 2006-236018 A

### SUMMARY

However, when accepting a return request from a purchasing customer, there is room for rationalizing the process of reselling the returned item.

An object of the present disclosure is to provide a server apparatus or the like that rationalizes the process of reselling a returned item.

A server apparatus according to the present disclosure includes a communication interface and a controller configured to transmit and receive information to and from another apparatus via the communication interface. The controller is configured to receive, from a first terminal apparatus, a collection request involving collection of a purchased or rented article to be returned at a collection point, receive, from a second terminal apparatus, a delivery request for the article involving delivery to a delivery destination, and transmit, to a mobile object, an instruction to collect the article at the collection point and deliver the article to the delivery destination without going through a base for storing the collected article.

A program according to the present disclosure is a program which, when executed by a terminal apparatus, causes the terminal apparatus to receive, from a server apparatus, promotion information that promotes purchase or use of a purchased of rented article to be returned and output the promotion information, and transmit, to the server apparatus, a location of a delivery destination for delivery of the article and a delivery request for the article, so that the article is delivered from a collection point at which the article is to be collected to the delivery destination without going through a base for storing the collected article.

An operation method according to the present disclosure is an operation method for an information processing system including a terminal apparatus, a server apparatus configured to transmit and receive information to and from the terminal apparatus, and a mobile object configured to transmit and receive information to and from the server apparatus. The method includes, the server apparatus receiving, from another terminal apparatus, a collection request for an article, purchased or rented, to be returned involving collection at a collection point; the terminal apparatus transmitting, to the server apparatus, a delivery request for the article involving delivery to a delivery destination; and the mobile object, upon receiving an instruction from the server apparatus to collect the article at the collection point and deliver the article to the delivery destination, moving from the collection point to the delivery destination without going through a base for storing the collected article.

According to the server apparatus or the like of the present disclosure, resale of a returned item can be rationalized.

### BRIEF DESCRIPTION OF THE DRAWINGS

In the accompanying drawings:

FIG. 1 illustrates an exemplary configuration of an information processing system;

FIG. 2 illustrates an exemplary configuration of a server apparatus;

FIG. 3 illustrates an exemplary configuration of a returning customer terminal apparatus;

FIG. 4 illustrates an exemplary configuration of a purchasing customer terminal apparatus;

FIG. 5 illustrates an exemplary configuration of a mobile object;

FIG. 6 is a sequence chart illustrating exemplary operations of an information processing system;

FIG. 7A illustrates an example of a range between a collection point and a base;

FIG. 7B illustrates an example of a range between a collection point and a base; and

FIG. 8 is a sequence chart illustrating exemplary operations of an information processing system.

### DETAILED DESCRIPTION

Hereinafter, an embodiment of the present disclosure will be described.

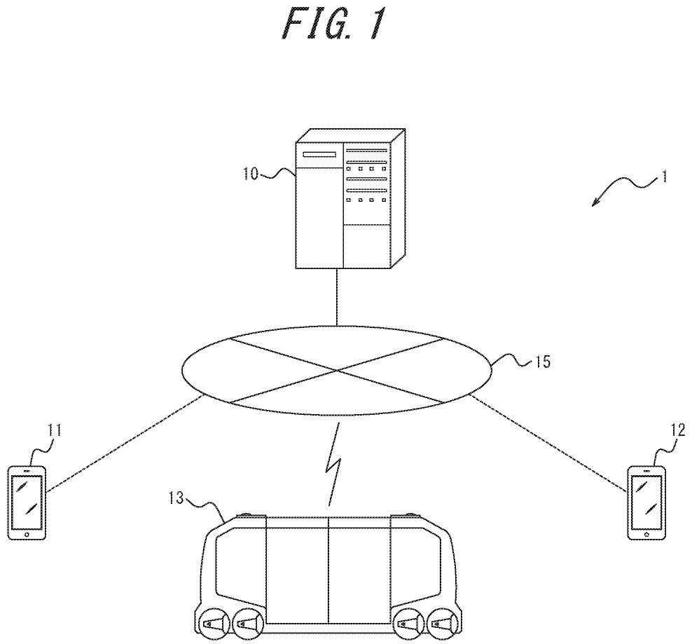

FIG. 1 illustrates an exemplary configuration of an information processing system according to an embodiment. An information processing system 1 supports resale of an article that is returned after being purchased, in a mail-order system through the Internet. Moreover, in a service form such as rental, the information processing system 1 is also capable of supporting processes from collection of an article that is returned after being used by a user up to re-lending to the next user. Here, an example of supporting resale of an article, that is, an item for sale, will be described. The information processing system 1 includes at least one server apparatus 10, at least one returning customer terminal apparatus 11, at least one purchasing customer terminal apparatus 12, and at least one mobile object 13, that are communicably connected to each other over a network 15, for example. The server apparatus 10 functions as, for example, an EC server for operating an EC website for selling items by a sales business operator, and also instructs operations, such as moving, to the mobile object 13. Each of the returning customer terminal apparatus 11 and the purchasing customer terminal apparatus 12 is an information terminal apparatus such as a personal computer, a tablet terminal apparatus, or a smartphone. Here, in operations relating to resale of an item that has been returned (hereinafter referred to as a returned item), a terminal apparatus used by a customer who returns a purchased item is referred to as the returning customer terminal apparatus 11, and a terminal used by a customer who purchases a returned item to be sold again is referred to as the purchasing customer terminal apparatus 12. The mobile object 13 is a transport vehicle that can be manually driven or automatically driven in manned or unmanned operation. The network 15 is, for example, the Internet, but includes an ad-hoc network, LAN, Metropolitan Area Network (MAN), another network, or a combination of any of them.

In the information processing system 1, resale of a returned item is performed as outlined below. When a purchasing customer wishes to return an item purchased from an EC website provided by the server apparatus 10, the purchasing customer operates the returning customer terminal apparatus 11 to transmit, to the server apparatus 10, a collection request of an item involving collection at a collection point. Then, the server apparatus 10 receives a delivery request of an item involving delivery to a delivery destination, from the purchasing customer terminal apparatus 12 operated by a purchasing customer. Then, the server apparatus 10 instructs the mobile object 13 to collect the item at the collection point and deliver the item to the delivery destination without passing through a base such as a warehouse for storing collected items. Then, the mobile object 13 moves to the collection point to collect the item to be returned, and transports it to the delivery destination to thereby deliver the item to the purchasing customer. In this way, according to the information processing system 1, a returned item can be sold again to another purchasing customer on a route from collection of the item to the base with a relatively short additional time, that is, a relatively small additional cost. Therefore, compared with the case in which the mobile object 13 returns to the base and then delivers it from the base to the delivery destination again, it is possible to reduce cost and to rationalize the resale process.

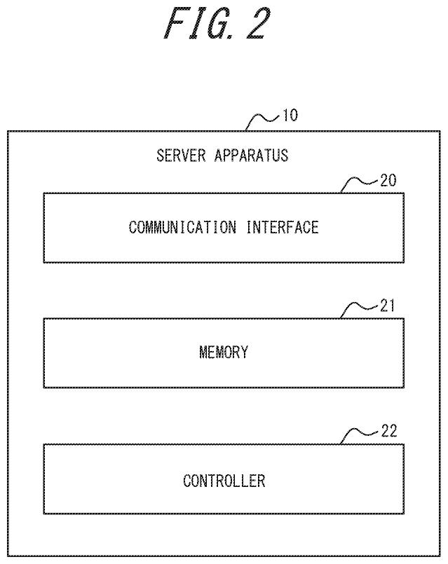

FIG. 2 illustrates an exemplary configuration of the server apparatus 10. The server apparatus 10 includes a communication interface 20, a memory 21, and a controller 22. The server apparatus 10 may perform the operations of the present embodiment through communication and cooperation with another server apparatus having a similar configuration.

The communication interface 20 includes at least one communication module conforming to wired or wireless LAN standards for connecting to the network 15. In the present embodiment, the server apparatus 10 is connected to the network 15 via the communication interface 20.

The memory 21 includes a semiconductor memory, a magnetic memory, an optical memory, or the like, for example. The memory 21 functions as a main memory, an auxiliary memory, or a cache memory, for example. The memory 21 stores, for example, any information to be used for operation of the server apparatus 10, control and processing programs, and member information of the EC website. The member information is transmitted from the returning customer terminal apparatus 11 or the purchasing customer terminal apparatus 12 to the server apparatus 10 at once. The member information includes, for example, member identification information such as ID number, name of the member, attributes such as age, and address.

The controller 22 includes, for example, at least one general-purpose processor such as a central processing unit (CPU) or at least one dedicated processor specialized in specific processing. Alternatively, the controller 22 may include at least one dedicated circuit such as Field-Programmable Gate Array (FPGA) or Application Specific Integrated Circuit (ASIC). The controller 22 collectively controls operation of the server apparatus 10 through operations in accordance with control and processing programs or operations in accordance with operation procedures implemented as circuits.

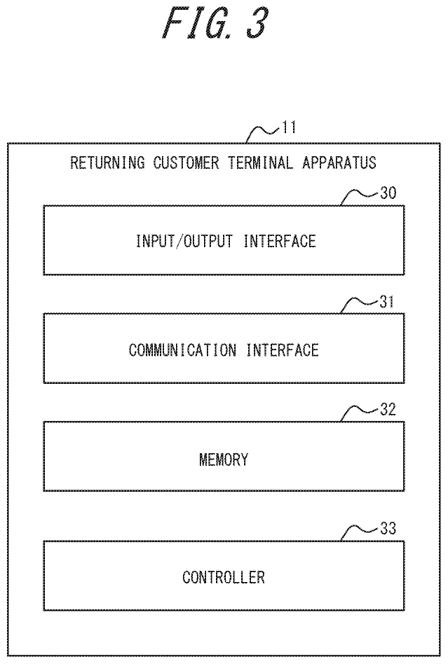

FIG. 3 illustrates an exemplary configuration of the returning customer terminal apparatus 11. The returning customer terminal apparatus 11 is an information processing terminal apparatus such as a personal computer, a tablet terminal apparatus, or a smartphone. The returning customer terminal apparatus 11 includes an input/output interface 30, a communication interface 31, a memory 32, and a controller 33.

The input/output interface 30 includes an input interface that detects an input from a user and transmits input information to the controller 33. Such an input interface is any suitable input interface including, for example, physical keys, capacitive keys, a touchscreen integrated with a panel display, various types of pointing devices, a microphone that accepts voice input, or a camera that fetches captured images or image codes. The input/output interface 30 also includes an output interface for outputting information generated by the controller 33 and information received from the server apparatus 10, to a user. Such an output interface is any suitable output interface including, for example, an external or integral display that outputs information as images or videos, a speaker that outputs information as sound, or a connection interface for connection with an external output device.

The communication interface 31 includes, for example, a communication module conforming to wired or wireless LAN standards, or a module conforming to a mobile communication standard such as 4th Generation (4G), 5th Generation (5G) standards, or the like. The returning customer terminal apparatus 11 is connected to the network 15 via a router apparatus in the vicinity thereof or a mobile communication base station, and performs information communication with the server apparatus 10 via the network 15, using the communication interface 31.

The memory 32 includes a semiconductor memory, a magnetic memory, an optical memory, or the like, for example. The memory 32 functions as a main memory, an auxiliary memory, or a cache memory, for example. The memory 32 stores any information to be used for operation of the returning customer terminal apparatus 11. For example, the memory 32 stores control and processing programs, application programs providing various functions to be downloaded via the network 15, and the like.

The controller 33 includes, for example, at least one general-purpose processor such as a CPU or a micro processing unit (MPU) or at least one dedicated processor specialized in specific processing. Alternatively, the controller 33 may include at least one dedicated circuit such as an FPGA, an ASIC, and the like. The controller 33 collectively controls operations of the returning customer terminal apparatus 11 through operations in accordance with the control and processing programs or operations in accordance with operation procedures implemented as circuits.

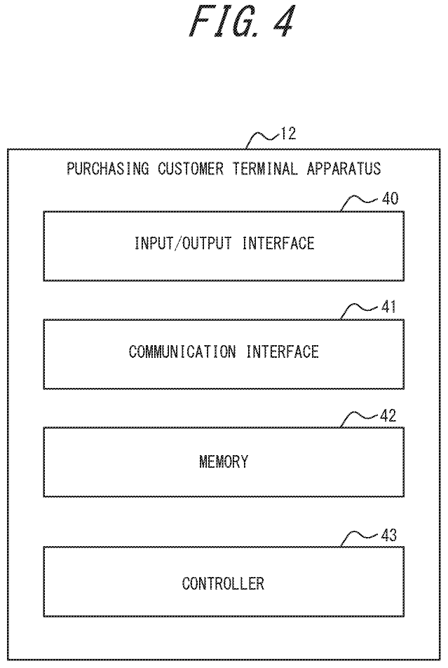

FIG. 4 illustrates an exemplary configuration of the purchasing customer terminal apparatus 12. The purchasing customer terminal apparatus 12 is an information processing terminal apparatus such as a personal computer, a tablet terminal apparatus, or a smartphone. The purchasing customer terminal apparatus 12 includes an input/output interface 40, a communication interface 41, a memory 42, and a controller 43. The input/output interface 40, the communication interface 41, the memory 42, and the controller 43 of the purchasing customer terminal apparatus 12 respectively have similar configurations to those of the input/output interface 30, the communication interface 31, the memory 32, and the controller 33 of the returning customer terminal apparatus 11 described with reference to FIG. 3.

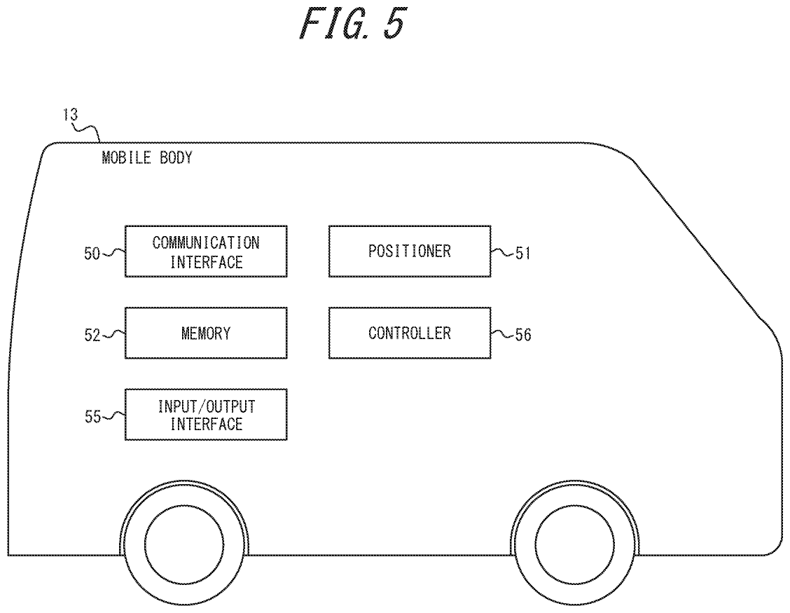

FIG. 5 illustrates an exemplary configuration of the mobile object 13. The mobile object 13 is a transport vehicle that can be manually driven or automatically driven in manned or unmanned operation. The mobile object 13 includes a communication interface 50, a positioner 51, a memory 52, an input/output interface 55, and a controller 56, and the respective parts are communicably connected to each other in a wired or wireless manner via an in-vehicle network such as a controller area network (CAN) or dedicated lines. Some or all of the communication interface 50, the positioner 51, the memory 52, the input/output interface 55, and the controller 56 may be directly provided to the mobile object 13, or may be provided to an information processing apparatus detachable from the mobile object 13 such as a car navigation apparatus. The mobile object 13 may be driven by a driver or driven automatically at any appropriate level. The automation level is, for example, any of level 1 to level 5 as defined by the Society of Automotive Engineers (SAE).

The communication interface 50 includes a communication module conforming to wired or wireless LAN standards, or a module conforming to a mobile communication standard such as 4G, 5G, or the like. The mobile object 13 is connected to the network 15 via a mobile communication base station by the communication interface 50, and performs information communication with the server apparatus 10 via the network 15.

The positioner 51 measures the position of the mobile object 13 and generates position information. The position information is information specifying a position on a map, including coordinates such as two-dimensional coordinates or three-dimensional coordinates, for example. The position information is not limited to coordinates. It may include speed, a moving route, a moving distance, or the amount of change or a rate of change thereof, or the like. The positioner 51 includes a receiver supporting a satellite navigation system. The satellite navigation system supported by the receiver may be the Global Positioning System (GPS). Alternatively, the positioner 51 may include an acceleration sensor or a gyro sensor. For example, the car navigation apparatus may function as the positioner 51.

The memory 52 includes a semiconductor memory, a magnetic memory, an optical memory, or the like, for example. The memory 52 functions as a main memory, an auxiliary memory, or a cache memory, for example. The memory 52 stores any information to be used for control of the operations of the mobile object 13. For example, the memory 52 stores control and processing programs, application programs providing various functions to be downloaded via the network 15, and the like.

The input/output interface 55 includes an input interface that detects an input from a user and transmits input information to the controller 56. Such an input interface is any suitable input interface including physical keys, capacitive keys, a touchscreen integrated with a panel display, various pointing devices, a microphone that accepts voice input, a camera that fetches captured images or image codes, or an IC card reader. The input/output interface 55 also includes an output interface for outputting information generated by the controller 56 and information received from the server apparatus 10, to a user. Such an output interface is any suitable output interface including, for example, an external or integrated display that outputs information as images or videos, a speaker that outputs information as sound, or a connection interface for connection with an external output device.

The controller 56 includes at least one general-purpose processor such as a CPU or an MPU or at least one dedicated processor specialized in specific processing. Alternatively, the controller 56 may include at least one dedicated circuit such as an FPGA, an ASIC, and the like. The controller 56 collectively controls operations of the mobile object 13 including the communication interface 50, the positioner 51, the memory 52, and the input/output interface 55, through operations in accordance with control and processing programs or operations in accordance with operation procedures implemented as circuits.

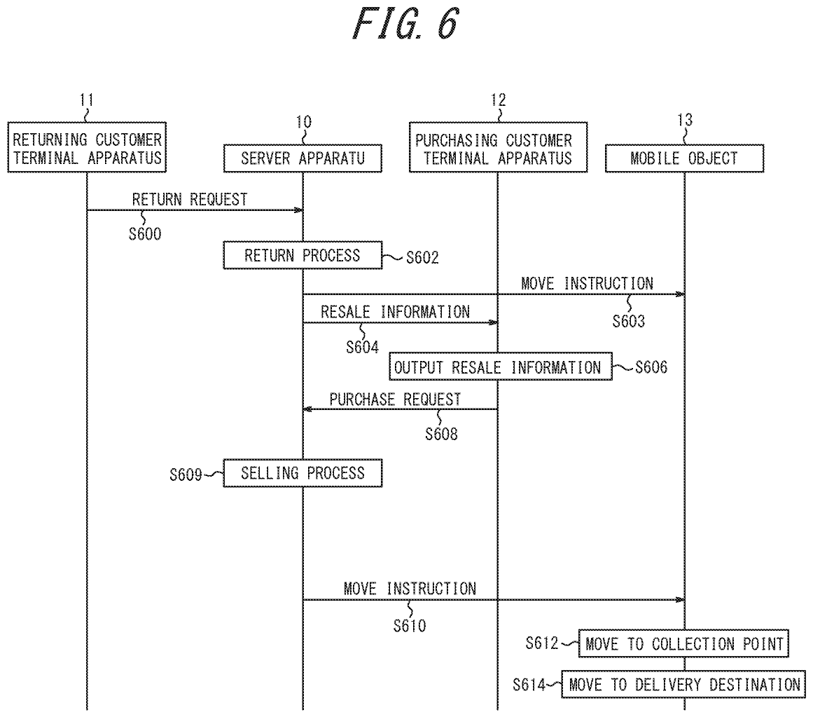

FIG. 6 is a sequence chart illustrating exemplary operations of the information processing system 1. The procedures in FIG. 6 are started when a returning customer who is a member of an EC website operates the returning customer terminal apparatus 11 to return an item purchased on the EC website. FIG. 6 illustrates steps in which information processing and control are performed by the server apparatus 10, the returning customer terminal apparatus 11, the purchasing customer terminal apparatus 12, and the mobile object 13 through transmission and reception of information to and from other apparatuses respectively. Each step corresponds to an operation of the controller of each apparatus. That is, transmitting and receiving of information to and from the controllers of other apparatuses is performed by the controller 22 via the communication interface 20 in the server apparatus 10, by the controller 33 via the communication interface 31 in the returning customer terminal apparatus 11, by the controller 43 via the communication interface 41 in the purchasing customer terminal apparatus 12, and by the controller 56 via the communication interface 50 in the mobile object 13, respectively. Then, information processing and control are performed by the controller 22 in the server apparatus 10, by the controller 33 in the returning customer terminal apparatus 11, by the controller 43 in the purchasing customer terminal apparatus 12, and by the controller 56 in the mobile object 13, respectively.

The returning customer terminal apparatus 11 transmits a return request involving collection of an item at a collection point to the server apparatus 10 in response to operation by the returning customer (step S600). The returning customer manually inputs the return request from, for example, a touch screen. The return request includes, for example, identification information at the time of purchasing the returned item, identification information of the purchasing process, and information related to the returning customer. The information related to the returning customer includes information such as an identification number and a name specifying the returning customer, and a location of the collection point for collecting the item. The item collection point is any point designated by the returning customer, which is an address for the returning customer, for example. The location includes address or coordinate information on the map information, for example. The server apparatus 10 acquires information related to the returning customer from the member information database of the EC website. Alternatively, each time an item is returned, the returning customer terminal apparatus 11 may transmit the location of the collection point to the server apparatus 10.

Next, the server apparatus 10 performs return processing in response to the return request (step S602). A return process includes, for example, update of inventory information for the item, and a process for refunding the item price to the financial account of the returning customer. In the server apparatus 10, for example, the controller 22 updates the inventory information and transaction history of the item stored in the memory 21. The transaction history includes, for example, item ID, user ID, transaction amount (item price), and settlement means (account information), and the like, in association with the transaction ID.

Next, the server apparatus 10 instructs the mobile object 13 to move to a collection point for collecting the returned item (step S603).

Then, the server apparatus 10 transmits resale information for promoting purchase of the returned item to the purchasing customer terminal apparatus 12 (step S604). At that time, the server apparatus 10 transmits resale information including an image of the returned item and item attributes to the purchasing customer terminal apparatus 12 of a member having a delivery destination between the collection point and the base, from among the preregistered members of the EC website.

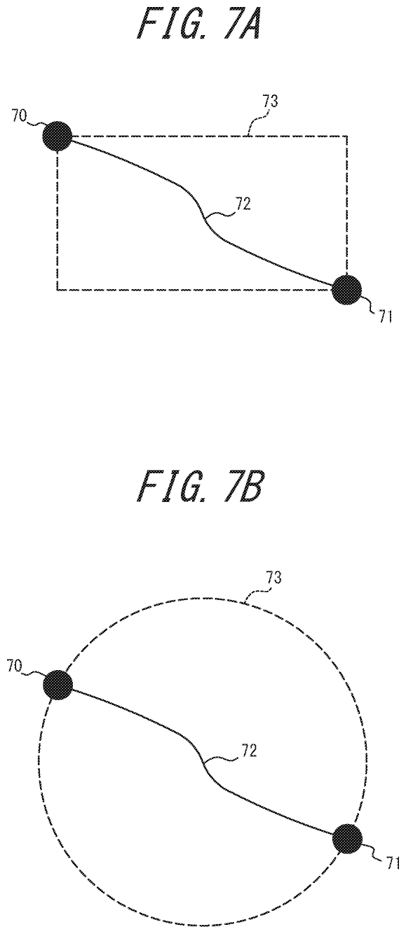

FIGS. 7A and 7B illustrate schematic examples of a collection point 70, a base 71, a route 72 from the collection point 70 to the base 71, and a range 73 determined to be located between the collection point 70 and the base 71 on a map. The route 72 is the route having the shortest distance or the route with the minimum required time from among possible routes from the collection point 70 to the base 71, for example. FIG. 7A illustrates an example of the rectangle range 73 in which a straight line linking the collection point 70 and the base 71 forms a diagonal line. FIG. 7B illustrates an example of the circular range 73 in which a straight line linking the collection point 70 and the base 71 forms the diameter. When the delivery destination is inside the ranges 73 illustrated in FIG. 7A or 7B, the server apparatus 10 determines that the delivery destination is located between the collection point 70 and the base 71.

Determination of whether or not the delivery destination is located between the collection point and the base can be made under a criterion other than that illustrated herein. For example, when N+L<M+2·L is satisfied, where M represents a time distance from the collection point to the base (here, the “time distance” represents the time to travel between two points as a distance), N represents a time distance from the collection point to the delivery destination, and L represents a time distance from the base to the delivery destination, that is, in the case in which the sum of the time distances when the mobile object 13 moves from the collection point to the base via the delivery destination is less than the sum of the time distances when the mobile object moves from the collection point to the delivery destination via the base and then returns to the base, it can be determined that the delivery destination is located between the collection point and the base. Alternatively, with reference to the costs (fuel cost of the mobile object 13, labor cost, and the like) based on the moving distance and the required time when the mobile object 13 moves from the collection point to the base, if the additional cost based on the moving distance and the required time when the mobile object 13 goes through the delivery destination is smaller than the additional cost based on the moving distance and the required time when the mobile object 13 moves to the delivery destination after temporarily going back to the base, it is determined that the delivery destination is located between the collection point 70 and the base 71. By accepting such a purchase request involving delivery to the delivery destination, the server apparatus 10 can resell the returned item to another purchasing customer with a relatively small additional cost on the collection route from collection of the item to the base. Accordingly, compared with the case in which the mobile object 13 temporarily goes back to the base and then delivers the item again from the base to the delivery destination, the cost can be reduced, and resale can be rationalized.

Further, the resale information provided from the server apparatus 10 to the purchasing customer terminal apparatus 12 at step S604 of FIG. 6 includes a resale price. The purchasing customer terminal apparatus 12 outputs the resale information to prompt the purchasing customer to purchase the returned item (step S606). The purchasing customer terminal apparatus 12 displays, for example, an image of the returned item, attributes of the item, and a resale price.

The resale price is the price when the returned item was purchased or is equal to or lower than the current list price. When the delivery destination is located between the collection point and the base, the server apparatus 10 reduces the resale price from the price when the returned item was purchased or the current list price. In that case, the server apparatus 10 determines the reduction amount for the resale price corresponding to the distance to the delivery destination from the route that the mobile object 13 moves from the collection point to the base. Here, the distance may be a moving distance on the map or a time distance. For example, the server apparatus 10 first derives a shortest distance from the collection point to the base, or an initial route that takes a minimum required time. Then, the server apparatus 10 derives a difference between the moving distance when moving to the base via the delivery destination and the initial route, or a difference in the required time. Then, the server apparatus 10 increases the reduced amount as the difference in the moving distance or the difference in the required time is smaller, while decreases the reduced amount as the difference is larger. For example, the upper limit of the reduction range, in which the cost merit obtainable by going through the delivery destination on the way from the collection point to the base is not offset by the reduction in the resale price, is set to reduction of 20%. In that case, the reduction range can be reduced by 1% for every 2000 m, that is, when the difference in the moving distance is 0 m to 4000 m, the reduction is 20%, when the difference is 4000 m to 6000 m, the reduction is 19%, and when the difference is 6000 m to 8000 m, the reduction is 18%. Alternatively, the reduction range can be reduced by 1% for every 5 minutes, that is, when the difference in the required time is 0 minutes to 10 minutes, the reduction is 20%, when the difference is 10 minutes to 15 minutes, the reduction is 19%, and when the difference is 15 minutes to 20 minutes, the reduction is 18%. The server apparatus 10 may store, for example, in the memory 21, a table in which a difference in the moving distance and required time is associated with the reduction range in advance, and determine the reduction amount based on the table.

Alternatively, for example, the amount of reduction may be determined by calculation in a manner such that in a range in which the difference in the moving distance exceeds 4000 m, the reduction range is reduced by 0.0005% per 1 m difference in the moving distance, or in a range in which the difference in the required time exceeds 10 minutes, the reduction range is reduced by 0.2% per 1 minute difference in the required time. The numerical values indicated herein are examples, and any appropriate numerical values and mathematical expressions can be used without any limitation.

In this way, it is possible to stimulate the willingness of a purchasing customer to purchase and more reliably perform resale. On the other hand, it is possible to secure profit by resale of the returned item by adjusting the reduction amount in the resale price such that the cost merit, obtainable by going through the delivery destination on the way from the collection point to the base, is not offset by the reduction.

When the server apparatus 10 transmits resale information to a plurality of purchasing customer terminal apparatuses 12, the reduction amount of the resale price is determined for each delivery destination corresponding to each purchasing customer terminal apparatus 12. In this way, it is possible to prompt a plurality of purchasing customers to make a purchase request, and when a purchase request from any of the purchasing customers is accepted, it is possible to secure profit by the resale.

By operation by a purchasing customer who wishes to purchase the returned item, the purchasing customer terminal apparatus 12 transmits a purchase request to the server apparatus (step S608). Then, in response to the purchase request, the server apparatus 10 performs a selling process for the returned item at a resale price presented to the purchasing customer (step S609). At that time, if purchase requests are made by a plurality of purchasing customer terminal apparatuses 12, the server apparatus 10 performs a selling process for the purchasing customer who transmitted the purchase request first, for example. Meanwhile, if purchase requests are made by a plurality of purchasing customer terminal apparatuses 12 within a predetermined time (for example, several minutes), the server apparatus 10 performs a selling process for a purchasing customer whose resale price is the highest (that is, the reduction amount is minimum), for example. In this way, the server apparatus 10 can select a purchasing customer on an arbitrary basis and performs a selling process.

Next, the server apparatus 10 instructs the mobile object 13 to move to a collection point and collect the returned item, and then move to the delivery destination for delivery of the returned item to the purchasing customer (step S610). In response to the instruction, the mobile object 13 moves to the collection point (step S612) and collects the returned item, and moves to the delivery destination to deliver the returned item to the purchasing customer (step S614). Alternatively, the mobile object 13 may start moving to the collection point in response to the moving instruction transmitted from the server apparatus 10 at step S603, and switch the route to a route going through the delivery destination after the collection point, in response to the moving instruction transmitted from the server apparatus 10 at step S610. At the collection point, for example, a crew member of the mobile object 13 may receive a returned item from the customer who returns the item and load it on the mobile object 13, or the customer who returns the item may load the returned item on the mobile object 13 driven by unmanned operation. At the delivery destination, for example, a crew member of the mobile object 13 may hand over the returned item to the purchasing customer, or the purchasing customer may unload the returned item from the mobile object 13 driven by unmanned operation. After delivery of the returned item to the delivery destination, the mobile object 13 moves to the base. Then, at the base, unloading of other returned items or loading of other items that have been purchased and are to be delivered are performed.

In a modification of the procedures of FIG. 6, the server apparatus 10 may omit step S603 in which the mobile object 13 is instructed to move to the collection point, and may instruct the mobile object 13 to move to the collection point and then go through the delivery destination at step S610.

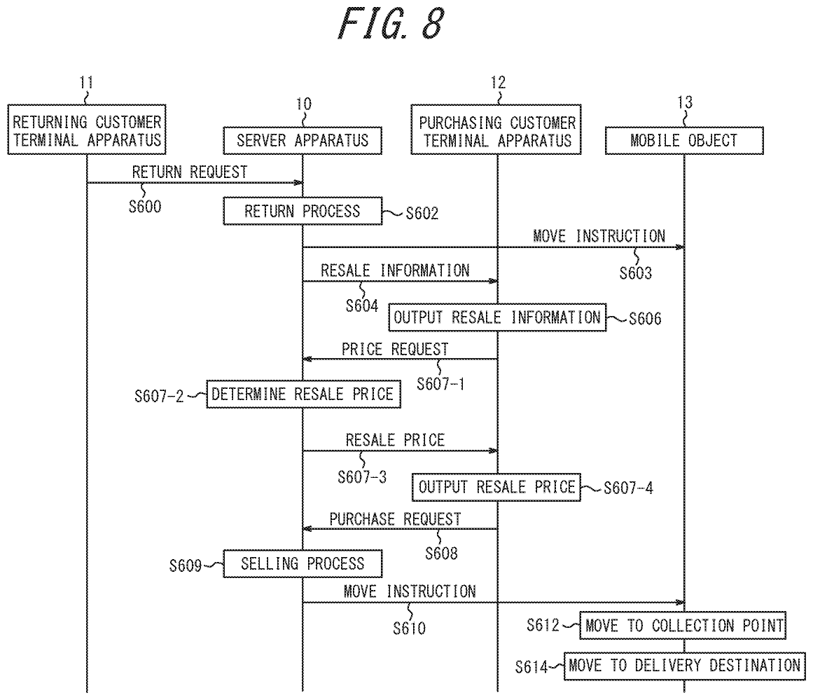

FIG. 8 is a sequence chart illustrating exemplary operations of the information processing system 1 in a modified example. Steps which are the same as those of FIG. 6 are denoted by the same reference numerals. In this modified example, at step S604, for example, the server apparatus 10 publishes resale information on the EC website so as to be viewable from the purchasing customer terminal apparatus 12 to thereby provide the purchasing customer terminal apparatus 12 with the resale information. In that case, the resale information includes an image of a returned item and attributes of the item. At this point, the resale price is withheld as secret price, for example.

In response to the operation by a purchasing customer who is interested in purchase by receiving output of the resale information (step S606), the purchasing customer terminal apparatus 12 transmits a price request to the server apparatus (step S607-1). At this time, the price request includes member identification information of the purchasing customer of the EC website. Then, the server apparatus 10 refers to the member information database and acquires the location of the delivery destination registered in advance. If the purchasing customer is not registered as a member of the EC website, the price request may include the location of the delivery destination, and the server apparatus 10 may acquire the location of the delivery destination from the price request.

When the server apparatus 10 acquires the location of the delivery destination, the server apparatus determines a resale price depending on the location of the delivery destination (step S607-2). For example, when the delivery destination is located between the collection point and the base, the server apparatus 10 determines a resale price that is reduced from the price when the returned item was purchased or from the current list price. Meanwhile, when the delivery destination is not located between the collection point and the base, the server apparatus 10 presents the price when the returned item was purchased or the current list price. Then, when determining the resale price that is reduced, the server apparatus 10 determines the reduced amount according to the distance to the delivery destination from the route from the collection point to the base. Then, the server apparatus 10 transmits the determined resale price to the purchasing customer terminal apparatus 12 (step S607-3). When the server apparatus 10 receives price requests from a plurality of purchasing customer terminal apparatuses 12, the server apparatus 10 determines the reduction amount for each delivery destination of each of the purchasing customer terminal apparatuses 12 and presents the resale price.

Next, the purchasing customer terminal apparatus 12 outputs the resale price to prompt the purchasing customer to purchase the returned item (step S607-4). At this time, the purchasing customer terminal apparatus 12 displays, for example, an image of the returned item, attributes of the item, and the resale price. Then, by the operation of the purchasing customer who wishes to purchase the returned item, the purchasing customer terminal apparatus 12 transmits a purchase request to the server apparatus (step S608).

Next, in response to the purchase request, the server apparatus 10 performs a selling process for the returned item at the resale price presented to the purchasing customer (step S609). Here, when receiving the purchase request from the purchasing customer terminal apparatus 12 of a purchasing customer whose delivery destination is located between the collection point and the base, the server apparatus 10 performs the selling process and instructs the mobile object 13 to move from the collection point to the delivery destination (step S610). On the other hand, when the purchase request is received from the purchasing customer terminal apparatus 12 of a purchasing customer whose delivery destination is not located between the collection point and the base, time and cost saving cannot be made by going through the delivery destination. Therefore, after performing the selling process, the server apparatus 10 changes the instruction to cause the mobile object 13 to move to the delivery destination after once coming back to the base.

This modified example enables resale of the returned item on the way from the collection point to the base, and also enables the server apparatus 10 to accept a purchase request from a purchasing customer whose delivery destination is not located between the collection point and the base without omission. This enables business opportunities to be secured more reliably.

The above examples describing resale of a returned item are also applicable to examples in which a rented and returned article is re-lent to the next user. Articles to be rented include articles that can be delivered and collected such as books, clothes, and home appliances. In such examples, a returning customer in the above description can be read as a rental returning customer who returns a rented article. Further, the returning customer terminal apparatus 11 is a terminal apparatus used by a rental returning customer. Then, instead of a return request, a rental return request is transmitted from the terminal apparatus of the rental returning customer to the server apparatus 10. Here, a return request and a rental return request correspond to a “collection request”. Further, a purchasing customer is read as a user who wishes to rent an article. The purchasing customer terminal apparatus 12 is a terminal apparatus used by a user of the article. Then, instead of resale information, re-lending information including a use fee (rental fee) is transmitted from the server apparatus 10 to the terminal apparatus of the user. Here, the resale information and re-lending information correspond to “promotion information”. Further, instead of a purchase request, a rental request involving delivery of an article to a delivery destination is transmitted from the terminal apparatus of the user to the server apparatus 10. Here, a purchase request and a rental request correspond to a “delivery request”. Then, the use fee is reduced corresponding to the location of the delivery destination designated by the user.

In the above, examples in which the mobile object 13 is a transport vehicle have been described, the mobile object 13 may be a flying object, for example.

In the above embodiment, processing and control programs defining the operations of the controller 33 of the returning customer terminal apparatus 11 and the controller 43 of the purchasing customer terminal apparatus 12 may be stored in a memory of the server apparatus 10 or another server apparatus and downloaded to each terminal apparatus over the network 15, or may be stored in a portable recording or storage medium readable by each terminal apparatus and read from the medium by each terminal apparatus. Further, processing and control programs defining the operations of the controller 56 of the mobile object 13 may be stored in a memory of the server apparatus 10 or another server apparatus and downloaded to the controller 56 of the mobile object 13 over the network 15, or may be stored in a portable recording or storage medium readable by controller 56 and read from the medium by the controller 56.

While embodiments have been described above based on the drawings and examples, it should be noted that various modifications or revisions may be readily implemented by those skilled in the art based on the present disclosure. Accordingly, such modifications and revisions are included within the scope of the present disclosure. For example, the functions and the like included in the respective means and respective steps can be rearranged so as not to contradict logically, and a plurality of means, steps, or the like can be combined into one or can be divided.

1. A server apparatus comprising:
a communication interface; and
a controller configured to transmit and receive information to and from another apparatus via the communication interface, wherein
the controller is configured to:
receive, from a first terminal apparatus, a collection request involving collection of an article, purchased or rented, to be returned at a collection point,
receive, from a second terminal apparatus, a delivery request for the article involving delivery to a delivery destination, and
transmit, to a mobile object, an instruction to collect the article at the collection point and deliver the article to the delivery destination without going through a base for storing the article collected.

2. The server apparatus according to claim 1, wherein
the controller is configured to provide the second terminal apparatus with promotion information to promote purchase or use of the article to be collected.

3. The server apparatus according to claim 2, wherein
the promotion information includes a resale price or a use fee for the article.

4. The server apparatus according to claim 3, wherein
the controller is configured to reduce the resale price or the use fee based on a distance to the delivery destination from a route from the collection point to the base.

5. The server apparatus according to claim 4, wherein
the controller is configured to determine an amount of the reduction for each delivery destination.

6. The server apparatus according to claim 2, wherein
the controller is configured to transmit the promotion information to the second terminal apparatus based on a previously acquired location of the delivery destination.

7. The server apparatus according to claim 2, wherein
the controller is configured to further provide a terminal apparatus associated with a delivery destination not located between the collection point and the base, with the promotion information.

8. An information processing system comprising the server apparatus according to claim 1 and a mobile object.

9. A mobile object configured to move from the collection point to the delivery destination based on the instruction received from the server apparatus according to claim 1.

10. A non-transitory medium readable by a controller of a mobile object, the medium storing a program which, when executed by the controller, controls the mobile object to move from the collection point to the delivery destination based on the instruction received from the server apparatus according to claim 1.

11. A non-transitory medium readable by a terminal apparatus, the medium storing a program which, when executed by the terminal apparatus, causes the terminal apparatus to:
receive, from a server apparatus, promotion information that promotes purchase or use of an article, purchased or rented, to be returned and output the promotion information, and
transmit, to the server apparatus, a location of a delivery destination for delivery of the article and a delivery request for the article, so that the article is delivered from a collection point at which the article is to be collected to the delivery destination without going through a base for storing the article collected.

12. The non-transitory medium readable by the terminal apparatus according to claim 11, wherein
the promotion information includes a resale price or a use fee of the article.

13. The non-transitory medium readable by the terminal apparatus according to claim 12, wherein
the resale price or the use fee is reduced according to a distance to the delivery destination from a route from the collection point to the base.

14. The non-transitory medium readable by the terminal apparatus according to claim 13, wherein
an amount of the reduction is determined for each delivery destination.

15. The non-transitory medium readable by the terminal apparatus according to claim 11, wherein
the promotion information is received from the server apparatus even when the delivery destination of the article, purchased or rented, to be returned is not located between the collection point for the article and a base for storing the article collected.

16. An operation method for an information processing system including a terminal apparatus, a server apparatus configured to transmit and receive information to and from the terminal apparatus, and a mobile object configured to transmit and receive information to and from the server apparatus, the method comprising:
the server apparatus receiving, from another terminal apparatus, a collection request for an article, purchased or rented, to be returned involving collection at a collection point;
the terminal apparatus transmitting, to the server apparatus, a delivery request for the article involving delivery to a delivery destination; and
the mobile object, upon receiving an instruction from the server apparatus to collect the article at the collection point and deliver the article to the delivery destination, moving from the collection point to the delivery destination without going through a base for storing the article collected.

17. The operation method according to claim 16, wherein
the server apparatus provides the terminal apparatus with promotion information to promote purchase or use of the article to be collected.

18. The operation method according to claim 17, wherein
the promotion information includes a resale price or a use fee for the article.

19. The operation method according to claim 18, wherein
the server apparatus acquires a location of the delivery destination in advance from the terminal apparatus, and reduces the resale price or the use fee based on a distance to the delivery destination from a route from the collection point to the base.

20. The operation method according to claim 19, wherein
the server apparatus determines an amount of the reduction for each delivery destination.
